(19) United States
(12) Patent Application Publication
(10) Pub. No.: US 2024/0253218 A1
(43) Pub. Date: Aug. 1, 2024

(54) METHOD AND SYSTEM FOR OPERATING A MACHINE

(71) Applicant: KUKA Deutschland GmbH, Augsburg (DE)

(72) Inventor: Matthias Kurze, Dachau (DE)

(73) Assignee: KUKA Deutschland GmbH, Augsburg (DE)

(21) Appl. No.: 18/561,182

(22) PCT Filed: Mar. 21, 2022
(86) PCT No.: PCT/EP2022/057297

§ 371 Date: Nov. 15, 2023

(30) Foreign Application Priority Data
May 17, 2021 (DE) 10 2021 204 935.4

(51) Int. Cl. B25J 9/16

(52) U.S. Cl. CPC B25J 9/163; B25J 9/1674

(57) ABSTRACT

A method for operating, in particular controlling and/or monitoring, a machine, in particular a robot includes: a) determining learning error values on the basis of model values, which are determined by a first model and a second model on the basis of machine state values, and on the basis of reference values of the machine; b) filtering the determined learning error values with a first filter and calibrating the first model on the basis of the filtered learning error values; c) filtering the determined learning error values with a second filter and calibrating the second model on the basis of the learning error values filtered by the second filter; and d) operating, in particular controlling and/or monitoring, the machine on the basis of model values determined by the calibrated first model and the calibrated second model on the basis of machine state values.

### CROSS-REFERENCE TO RELATED APPLICATIONS

This application is a national phase application under 35 U.S.C. § 371 of International Patent Application No. PCT/EP2022/057297, filed Mar. 21, 2022 (pending), which claims the benefit of priority to German Patent Application No. DE 10 2021 204 935.4, filed May 17, 2021, the disclosures of which are incorporated by reference herein in their entirety.

### TECHNICAL FIELD

The present invention relates to a method for operating, in particular controlling and/or monitoring, a machine, in particular a robot, and to a system and a computer program or computer program product for carrying out the method.

### BACKGROUND

Machines are frequently operated, for example controlled, monitored or the like, on the basis of models. Models used for this purpose frequently contain nonlinearities, for example resistances in drive trains, inter alia friction and drive torque fluctuation, so-called ripple or cogging, or model these (among other things).

Learning such nonlinearities by machine learning or calibrating models accordingly is already known from internal company practice. This becomes problematic if learning errors jointly result from a plurality of nonlinearities, for example both friction and drive torque fluctuation as mentioned above.

### SUMMARY

The object of the present invention is to improve the operation of a machine.

This object is achieved by a method, a system, and a computer program or computer program product, respectively, for carrying out a method described as herein.

According to one embodiment of the present invention, a method for operating a machine comprises the steps of:
a) determining learning error values on the basis of model values, which are determined by means of a first model and a second model on the basis of machine state values, and on the basis of reference values of the machine, in particular by comparing the model values and reference values;
b) filtering the (said) determined learning error values by means of a first filter and calibrating, in particular by (further) machine learning or by training, the first model on the basis of said learning error values filtered by means of the first filter;
c) filtering the (same) determined learning error values by means of a second filter and calibrating, in particular by (further) machine learning or by training, the second model on the basis of said learning error values filtered by means of the second filter; and
d) operating the machine on the basis of model values determined by means of the calibrated first model and the calibrated second model on the basis of machine state values.

One embodiment of the present invention is based on the idea of filtering out, by corresponding (first or second) filters in a targeted manner, effects which result from a nonlinearity (which is modeled by the second or first model), so that the corresponding nonlinearity can be better machine-learned. In particular, for the machine learning of one nonlinearity or the calibration of one model, effects that result from the other nonlinearity or one or more other nonlinearities can be reduced. In one embodiment, the first and second models can thereby be improved, in particular better calibrated or machine-learned, and thus the operation of the machine by means of these models can be improved, in particular a precision and/or reliability can be increased. The first and second models can be integrated together in an (overall) model.

Within the meaning of the present invention, operating can comprise, in particular can be, in particular controlling and/or monitoring; for more compact presentation, both closed-loop control and open-loop control are described by the general term “controlling”.

The machine can have, in particular can be, in particular a robot, which in one embodiment has at least three, in one embodiment at least six, in one development at least seven, joints or (movement) axes, in one embodiment a robotic arm having at least three, in one embodiment at least six, in one embodiment at least seven, joints or (movement) axes.

The present invention is particularly suitable for this purpose, in particular due to the dynamics of robots or the requirements in controlling or monitoring, without being limited thereto.

In one embodiment, the first and/or second model is a nonlinear model or models a nonlinearity or a nonlinear effect, in one embodiment a friction, a drive torque fluctuation or the like.

Within the meaning of the present invention, calibrating a model can comprise, in particular can be, in particular machine learning or training of the corresponding model.

In one embodiment, the step sequence a)-d) is repeated cyclically such that, in a current cycle, in step a) the model values are determined by means of the first and second models calibrated in steps b) and c) of a preceding cycle. In other words, in one embodiment the first and second models are (further) calibrated while the machine works or is in model-based operation, in one embodiment the robot moves or is in model-based operation. In this way, in one embodiment the operation of the machine can be (further) improved.

In one embodiment, the first model has a function approximator based on parameter-weighted, in one development aperiodic, basis functions or activation functions, in one embodiment a radial basis function network or a general regression neural network. The basis functions or activation functions can comprise, in particular can be, in particular Gaussian bell curves or the like.

Additionally or alternatively, in one embodiment the second model has a function approximator based on parameter-weighted, in one development periodic, basis functions or activation functions, in one embodiment a harmonic activated neural network.

Calibrating the model then can comprise, in particular can be, in particular varying the (parameter) weighting of the corresponding basis functions or activation functions.

In one embodiment, in particular when a nonlinearity represented by the first model is aperiodic and/or a nonlinearity represented by the second model is periodic, as is the case, for example, for friction and drive torque fluctuation, the operation of the machine can thereby be (further) improved, in particular a precision and/or reliability can be (further) increased.

In one embodiment, one of the first and second filters has, in particular can be, a notch filter or a band-stop filter.

Additionally or alternatively, in one embodiment the other of the first and second filters has, in particular can be, a band-pass filter, preferably a band-pass filter complementary or counter or opposite to the notch filter or band-stop filter. In one embodiment, complementary band-pass and notch or band-stop filters have at least substantially mutually corresponding notch frequencies or frequency bands, such that frequencies which are (strongly or more strongly) reduced or filtered (out) by the notch or band-stop filter are not reduced or are reduced little or less by the band-pass filter and vice versa. In one embodiment, these notch frequencies or frequency bands correspond to a periodicity of the second model.

In one embodiment, in particular when a nonlinearity represented by one of the models is aperiodic and/or a nonlinearity represented by the other of the models is periodic, as is the case, for example, for friction and drive torque fluctuation, the machine learning or corresponding model can thereby be improved, in particular better calibrated, and thus the operation of the machine by means of these models can be (further) improved, in particular a precision and/or reliability can be (further) increased.

In one embodiment, the first filter is a machine-state-value-adaptive filter whose filter behavior varies with the machine state values.

Additionally or alternatively, in one embodiment the second filter is a machine-state-value-adaptive filter whose filter behavior varies with the machine state values.

In one embodiment, the frequency band of the band-pass filter and/or the notch frequency or the frequency band of the notch or band-stop filter depends on the machine state value for which or in the case of which the learning error in question is determined, and in one embodiment the notch frequency or the frequency band of the notch or band-stop filter and/or of the band-pass filter corresponds to a speed, in particular a rotational speed, of the machine, and the machine state values can comprise, in particular can be, corresponding speed values, in particular rotational speed values, or the notch frequency or the frequency band of the notch or band-stop filter and/or of the band-pass filter has the machine state value or speed value, in particular rotational speed value, in question.

In one embodiment, the machine learning or corresponding model can thereby be improved, in particular better calibrated, and thus the operation of the machine by means of these models can be (further) improved, in particular a precision and/or reliability can be (further) increased.

In one embodiment, the model values and reference values depend on forces and/or torques of the machine, in particular can have, in one embodiment can be, forces and/or torques of the machine.

Additionally or alternatively, in one embodiment the machine state values depend on speeds, in particular rotational speeds, of the machine, in particular can have, in one embodiment can be, speeds, in particular rotational speeds, of the machine.

The present invention is particularly suitable for this purpose, in particular due to the characteristic of such model values or reference values or machine state values, without the invention being limited thereto.

A system according to one embodiment of the present is configured, in particular in terms of hardware and/or software, in particular in terms of programming, to carry out a method described herein and/or comprises:
means for determining learning error values on the basis of model values, which are determined by means of a first model and a second model on the basis of machine state values, and on the basis of reference values of the machine;
means for filtering the determined learning error values by means of a first filter and calibrating the first model on the basis of said learning error values filtered by means of the first filter;
means for filtering the determined learning error values by means of a second filter and calibrating the second model on the basis of said learning error values filtered by means of the second filter; and
means for operating, in particular controlling and/or monitoring, the machine on the basis of model values determined by means of the calibrated first model and the calibrated second model on the basis of machine state values.

In one embodiment, the system or the means thereof are configured to cyclically repeat the step sequence a)-d) such that, in a current cycle, in step a) the model values are determined by means of the first and second models calibrated in steps b) and c) of a preceding cycle.

A system and/or a means within the meaning of the present invention may be designed in hardware and/or in software, and in particular may comprise at least one data-connected or signal-connected, in particular, digital, processing unit, in particular microprocessor unit (CPU), graphic card (GPU) having a memory and/or bus system or the like and/or one or multiple programs or program modules. The processing unit may be designed to process commands that are implemented as a program stored in a memory system, to detect input signals from a data bus and/or to output output signals to a data bus. A storage system may comprise one or a plurality of, in particular different, storage media, in particular optical, magnetic, solid-state, and/or other non-volatile media. The program may be designed in such a way that it embodies or is capable of carrying out the methods described herein, so that the processing unit is able to carry out the steps of such methods and thus, in particular, is able to operate the machine.

In one embodiment, a computer program product may comprise, in particular be, a storage medium, in particular computer-readable and/or non-volatile, for storing a program or instructions or with a program stored thereon or with instructions stored thereon. In one embodiment, execution of said program or instructions by a system or controller, in particular a computer or an arrangement of a plurality of computers, causes the system or controller, in particular the computer or computers, to carry out a method described herein or one or more steps thereof, or the program or instructions are adapted to do so.

In one embodiment, one or more, in particular all, steps of the method are performed completely or partially automatically, in particular by the system or its means.

In one embodiment, the system comprises the machine.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 shows a system during the operating of a machine according to one embodiment of the present invention.

### DETAILED DESCRIPTION

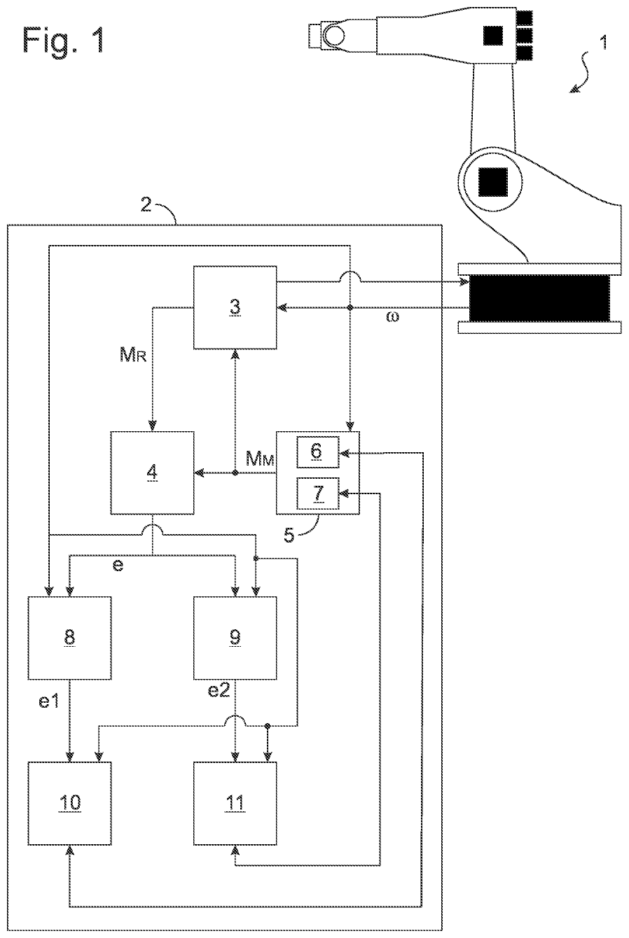

FIG. 1 shows, on the one hand, (the structure of) a system for operating a machine according to one embodiment of the present invention and, on the other hand, a method for operating the machine according to one embodiment of the present invention, said method being carried out by said system.

The system comprises a multi-axis robot 1 and the controller 2 of the robot.

A control and/or monitoring means 3 of the controller 2 receives machine state values, for example rotational speeds ω of the drives of the robot, from the robot 1.

A learning-error means 4 receives regulator setpoint torques M_{R} as reference values from the control and/or monitoring means 3 and receives corresponding model-calculated motor torques M_{M} as model values from a model means 5, which comprises a first model in the form of a general regression neural network 6 for modeling friction in one or more of the drive trains of the robot 1 and a second model in the form of a harmonic activated neural network 7 for modeling drive torque fluctuation in this drive train or these drive trains.

By subtracting these model values and reference values from one another, the learning-error means 4 determines learning error values e.

These are fed to a first filter 8 in the form of an adaptive notch filter G1=(s²+ω²)/(s²+2ωs+ω), the notch frequency of which corresponds to the rotational speed ω in question, and, in parallel, to a second filter 9 in the form of a complementary adaptive band-pass filter G2=1−G1=2ωs/(s²+2ωs+ω²), the frequency band of which analogously allows passing at the rotational speed ω in question.

The learning error values e1 filtered by means of the first filter 8 are fed to a training means 10, which trains the first model 6, in particular varies its weightings of basis functions or activation functions in the form of Gaussian bell curves accordingly.

The learning error values e2 filtered by means of the second filter 9 are fed to a training means 11, which trains the second model 7, in particular varies its weightings of harmonic basis functions or activation functions accordingly.

The first and second models are thereby calibrated or machine-learned. In the exemplary embodiment, the friction torques determined by the first model and the cogging torques determined by the second model are added, since they are also additively superposed in the drive trains.

The control and/or monitoring means 3 receives, from the model means 5, corresponding values for the resistances in the drive trains, which the model means determines by means of the calibrated first model 6 and the calibrated second model 7 on the basis of the current machine state values ω, and the control and/or monitoring means controls and/or monitors the robot 1 on the basis of these model-determined resistances, for example in that the control and/or monitoring means at least partially compensates the nonlinear effects of the friction and of the drive torque fluctuation and thereby improves the operation, in particular the system dynamics, in particular with regard to stability, robustness and/or control quality.

By adjustment of the (parameter) weighting while the robot works, in particular resistance changes or torque changes due to temperature fluctuations, wear, load (changes), stress or the like can be at least partially compensated.

The present invention was explained in particular on the basis of the application case of nonlinear friction and nonlinear (torque) ripple which occur in drive trains of machines, in particular robots, since both effects are very complex to model and are dependent on a plurality of influencing factors; however, the invention is not limited thereto.

In order to adapt the (parameter) weighting, optimization methods such as the gradient descent method or a recursive least-squares algorithm can be used in particular.

In the exemplary embodiment, the invention is used for simultaneous identification or calibration and compensation of nonlinear friction and nonlinear torque ripples on the basis of a learning error, while the robot works. The deviation between the model-calculated motor torque and the regulator setpoint torque is used as learning error.

In the exemplary embodiment, the basis for the identification or calibration is the use of function approximators. These are constructed as follows in the exemplary embodiment:

A specified number of basis functions or activation functions is distributed over the input space and weighted with parameters. The course of the approximated function then results from the addition of all weighted basis functions.

For friction, it is appropriate to use Gaussian bell curves as basis functions or activation functions and to distribute them over the relevant rotational speed range.

For the torque ripple, it is appropriate, due to the periodic course in dependence on the motor position, to use harmonic basis functions or activation functions.

Both nonlinearities generate nonlinear torques and influence the learning error. It is therefore generally proposed that the learning error be filtered in a suitable manner before it is used to adapt the weights. Since in this case the frequency of the torque ripple is dependent on the motor rotational speed w, the learning error is filtered by means of an adaptive notch filter with the transfer function G1(s,ω). The notch frequency is adapted according to the motor rotational speed. It is thereby achieved that the influence of the nonlinear torque ripple is masked out and in this respect the notch-filtered learning error results only from the influence of the nonlinear friction. The weights of the general regression neural network (GRNN) can thus be correctly adapted on the basis of the notch-filtered learning error, so that ultimately the friction can be correctly identified or modeled or the model can be calibrated or machine-learned. Furthermore, the learning error is filtered by means of an adaptive band-pass filter with the transfer function G2(s,ω)=1−G1(s,ω). It is thereby achieved that, in this respect, the learning error results only from the influence of the torque ripple. On the basis of this band-pass filtered learning error, the weights of the harmonic activated neural network (HANN) can thus be correctly adapted, so that the amplitude and phase of the ripple are correctly identified or the model is calibrated or machine-learned.

Although embodiments have been explained in the preceding description, it is noted that a large number of modifications are possible. It is also noted that the embodiments are merely examples that are not intended to restrict the scope of protection, the applications, and the structure in any way. Rather, the preceding description provides a person skilled in the art with guidelines for implementing at least one embodiment, various changes—in particular with regard to the function and arrangement of the described components—being able to be made without departing from the scope of protection as it arises from the claims and from these equivalent combinations of features.

While the present invention has been illustrated by a description of various embodiments, and while these embodiments have been described in considerable detail, it is not intended to restrict or in any way limit the scope of the appended claims to such de-tail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

### LIST OF REFERENCE SIGNS

1 Robot (machine)
2 Controller
3 Control and/or monitoring means
4 Learning-error means
5 Model means
6 General regression neural network (GRNN; first model)
7 Harmonic activated neural network (HANN; second model)
8 Adaptive notch filter (first filter)
9 Adaptive band-pass filter (second filter)
10 Training means
11 Training means
e Learning error
e1 Filtered learning error
e2 Filtered learning error
M_{R} Regulator setpoint torque (reference values)
M_{M} Model-calculated motor torque (model value)
ω Rotational speed

What is claimed is:

1. A method for operating, in particular controlling and/or monitoring, a machine, in particular a robot (1), the method comprising the steps of:
a) determining learning error values (e) on the basis of model values (MM), which are determined by means of a first model (6) and a second model (7) on the basis of machine state values (□), and on the basis of reference values (MR) of the machine;
b) filtering the determined learning error values by means of a first filter (8) and calibrating the first model on the basis of said learning error values (e1) filtered by means of the first filter;
c) filtering the determined learning error values by means of a second filter (9) and calibrating the second model on the basis of said learning error values (e2) filtered by means of the second filter; and
d) operating, in particular controlling and/or monitoring, the machine on the basis of model values determined by means of the calibrated first model and the calibrated second model on the basis of machine state values.

2-8. (canceled)
